(19) United States
(12) Patent Application Publication
(10) Pub. No.: US 2008/0198131 A1
(43) Pub. Date: Aug. 21, 2008

(54) Temperature Feedback PC Pointing peripheral

(76) Inventor: Christopher Rondot, L'Ange Gardien (CA)

Correspondence Address: Christopher Rondot, 6368 Ave Royale, L'Ange Gardien, QC, G0A 2K0, omitted

(21) Appl. No.: 11/675,271

(22) Filed: Feb. 15, 2007

(51) Int. Cl. G06F 3/033

(52) U.S. Cl. 345/158

(57) ABSTRACT

A new pointing device implementation method that uses temperature sensors mounted on or in a personal computing device's pointing device or game console's game controller to collect and effectively send temperature information about the surface of the peripheral pointing device to the connected personal computing device or game console for use by the software running on the device. The software running on the personal computing device or game console connected to the peripheral pointing device or game controller also sends data instructions specifying the desired temperature for which the surface of the pointing peripheral should be. In response to the instructions sent by the game console or personal computing device, the device heats up or cools down to reflect the context of the video game or software running on the screen or display.

### SUMMARY OF THE INVENTION

This apparatus collects and transmits information related to the surface of a computer pointing device such as a mouse, game controller or pen stylus, but not limited to these embodiments. Sensors are mounted on or inside the pointing device which determine the temperature of the computer or game console peripheral's case surface at any given time. The information is then sent to the personal computing device or game console that the pointing device or game controller is connected to for use by the computer software running on that personal computing device or game console. This information can be sent to the personal computing device or game console by the same means as the pointing coordinates in the case of a mouse or game controller, or by another method in the case of a stylus pen. The software inside the personal computing device or game console also sends data to the apparatus inside the pointing device or game controller peripheral connected to it to reflect the context of a visual program that is being run on the game console or personal computing device, The game controller or pointing device connected to it, then changes the temperature of it's surface area in accordance with the software requests that are sent to it by means of the apparatus. For example but not limited to these embodiments;

### Game Controller Embodiment:

It is cold in a game, winter, the game controller cools down. You are in a firey pit in a game, the game controller heats up. The user's hand gets hot, the software is able to read the temperature change and adjusts to regulate back to the right temperature.

### Mouse Embodiment:

A child is learning about hot and cold. They see an image of a kettle on the screen, the computer mouse heats up, letting them know it's hot. A picture of an ice cube is shown by the computer software, the mouse cools down. Their hand gets hot, the software is able to read the temperature change and adjusts to regulate back to the right temperature.

### Sylus Pen Embodiment;

A world map is shown on a tablet PC. The person using the stylus points to Siberia, the pen cools down. They point to Florida, the pen heats up. Their hand gets hot, the software is able to read the temperature change and adjusts to regulate back to the right temperature.

In one embodiment, heat and cold are dispersed within the apparatus via heat conductive materials, such as metal in small pads. In another, liquid or air could be circulated around the casing of the game controller or pointing device peripheral to heat up or cool down the surface of the peripheral using the apparatus.

The pads or air or liquid heating and cooling ducts would typically be mounted directly under the surface of the apparatus casing. In one embodiment, the electronic temperature sensors are mounted directly into the surface of the peripheral casing.

### BACKGROUND

Since the 1970s with the invention of the computer mouse at Xerox labs, we have been using various devices to collect and input information into computing devices. Most of this information has been related to pointing, and selecting different virtual items shown to us on a computer display device. One critical dimension has been missing from though. Which is that a computer can also benefit from interactions with the user based on the user's human physical condition. The apparatus permits computer software and applications to not only have data to determine the coordinate of an intended point on in virtual space, but to collect temperature data from the surface of the peripheral pointing device of a personal computing device, or game controller of a game console and emit heat or cold throughout the surface of the peripheral pointing device or game controller in context with what is being displayed on the screen by the software controlling the peripheral.

### DETAILED DESCRIPTION

### Definitions:

Apparatus: The invention

Data instructions: binary or clear text instructions sent to or from a computing device that prompt action of some sort by a software computer program.

Data Bus: a path for which In/Out of data can be performed between electronic computing devices.

Interrupts: software or hardware breaks in a controlled data flow which indicate that action should be taken on behalf of an connected device.

Temperature sensor: Diodes and other electronic components comprising a device that reads and transmits information about temperature

Software: a set of instructions directing a computer to perform meaningful tasks

Mouse: A hand held pointing device that transmits information used to determine screen or other coordinates to a computing device on x,y and sometimes z coordinates on a 2d or 3d plane.

Stylus pen: A hand held pointing, writing and or drawing device used in the collection of information used to determine screen or other coordinates to a computing device on x,y and sometimes z coordinates on a 2d or 3d plane.

Game Controller: A device usually hook up to a game console which allows a user to navigate through a video game or play the game on a display.

Game Console: a computer gaming system which allows users to play video games

Temperature Control/Changing Emitters: a heating or refrigeration system embedded in the case of the peripheral device who's job it is to make the device surface hotter or colder.

### DRAWINGS

1. Mouse embodiment using apparatus, temperature sensing

2. Stylus Pen embodiment using apparatus, temperature sensing

3. Game Controller embodiment using apparatus, temperature sensing

4. Mouse embodiment using apparatus, temperature emitting

5. Stylus Pen embodiment using apparatus, temperature emitting

6. Game Controller embodiment using apparatus, temperature emitting

7. Temperature emitting pad embodiment using apparatus component, temperature emitting

8. Flow chart of data requests and responses between apparatus and game console or PC device

9. Liquid or air cooled and heated embodiment of apparatus, temperature emitting

### DETAILED DESCRIPTION OF DRAWINGS

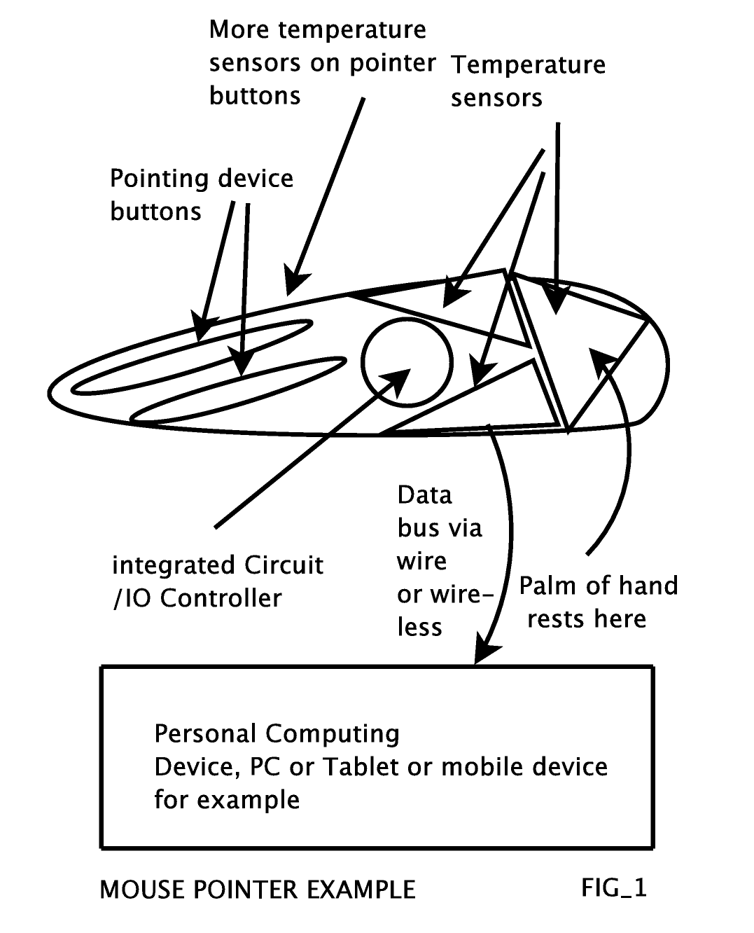

### FIG. 1—

Shows the pointing personal computing device peripheral embodiment as a mouse. The mouse has electronic components comprising of temperature sensors within it, and is transmitting data instructions and or interrupts to the attached personal computing device through an integrated circuit emitting data on a data bus to the PC device host.

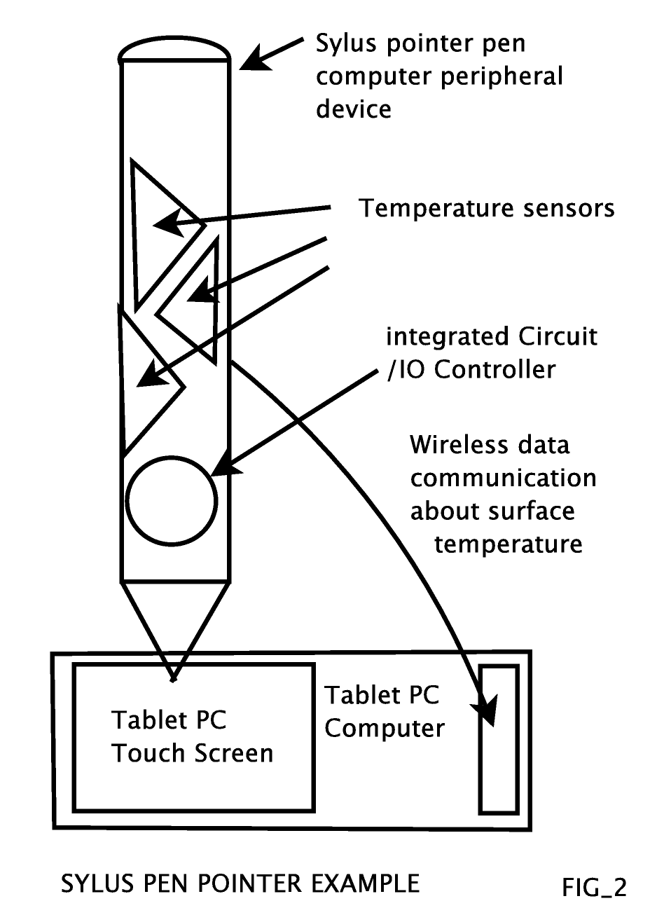

### FIG. 2—

Shows the pointing personal computing device peripheral embodiment as a stylus pen. The stylus pen has electronic components comprising of temperature sensors within it, and is transmitting data instructions and or interrupts to the attached personal computing device through an integrated circuit emitting data on a data bus to the PC device host.

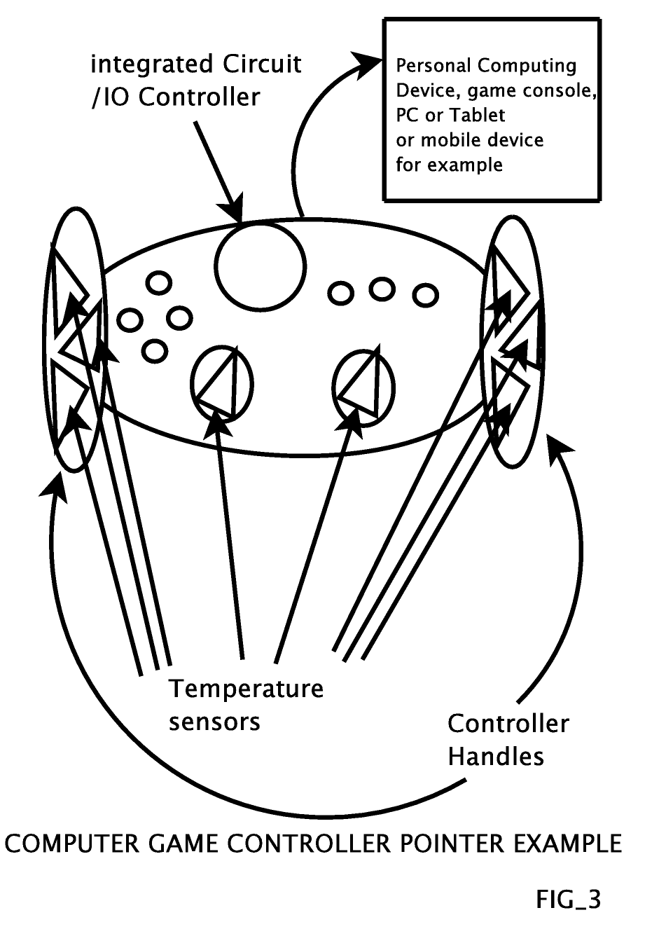

### FIG. 3—

Shows the pointing personal computing device peripheral embodiment as a game controller. The game controller has electronic components comprising of temperature sensors within it, and is transmitting data instructions and or interrupts to the attached game console through an integrated circuit emitting data on a data bus to the PC device host.

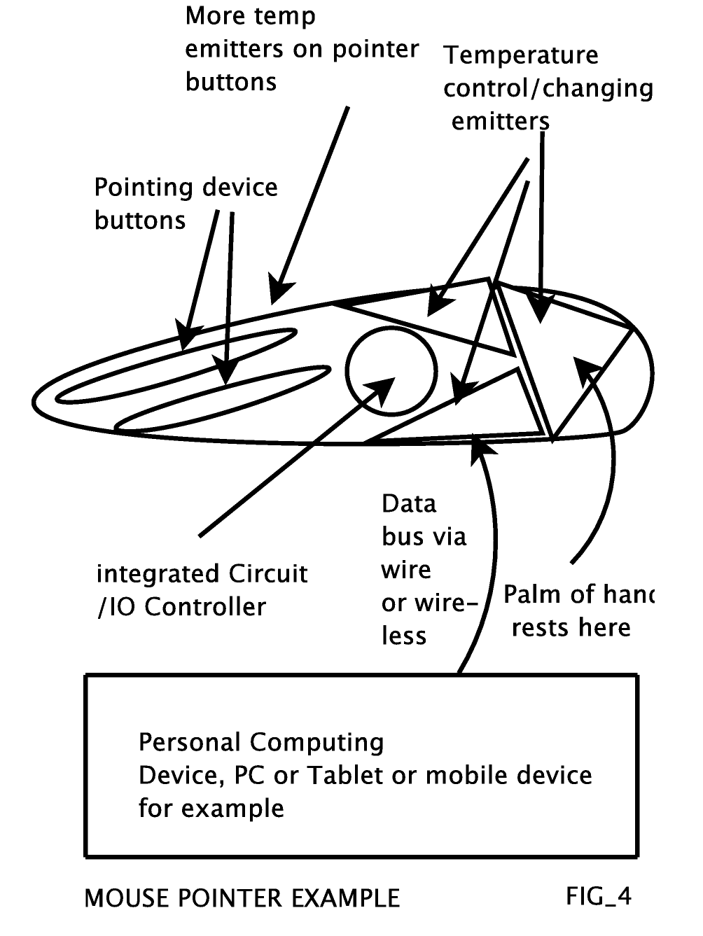

### FIG. 4—

Shows the pointing personal computing device peripheral embodiment as a mouse. The mouse has electronic components comprising of pads that conduct heat or cold throughout the surface of the device and does so based on binary or other software instructions sent to it from a PC device via a data bus.

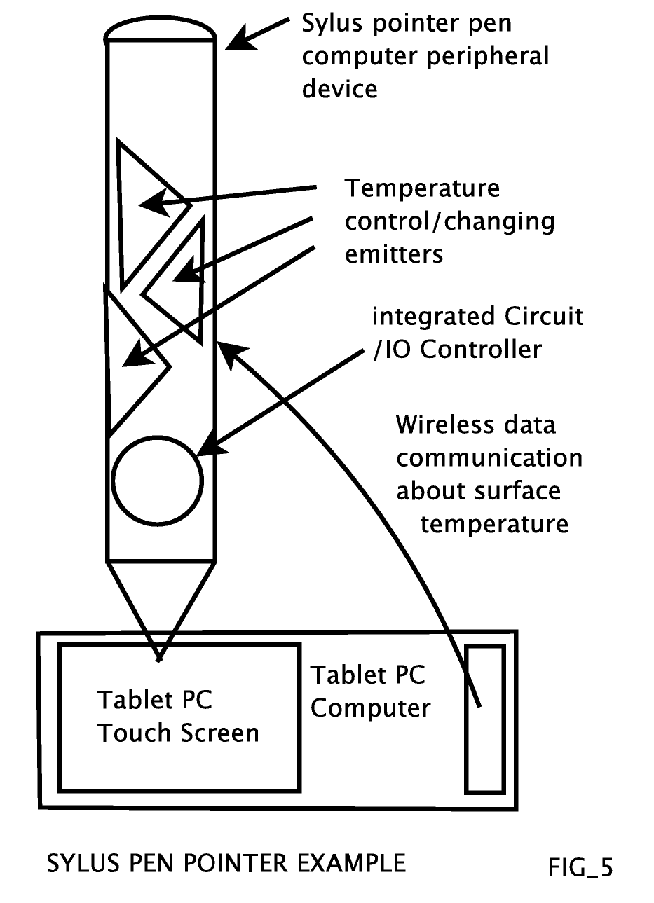

### FIG. 5—

Shows the pointing personal computing device peripheral embodiment as a stylus pen. The stylus pen has electronic components comprising of pads that conduct heat or cold throughout the surface of the device and does so based on binary or other software instructions sent to it from a PC device via a data bus.

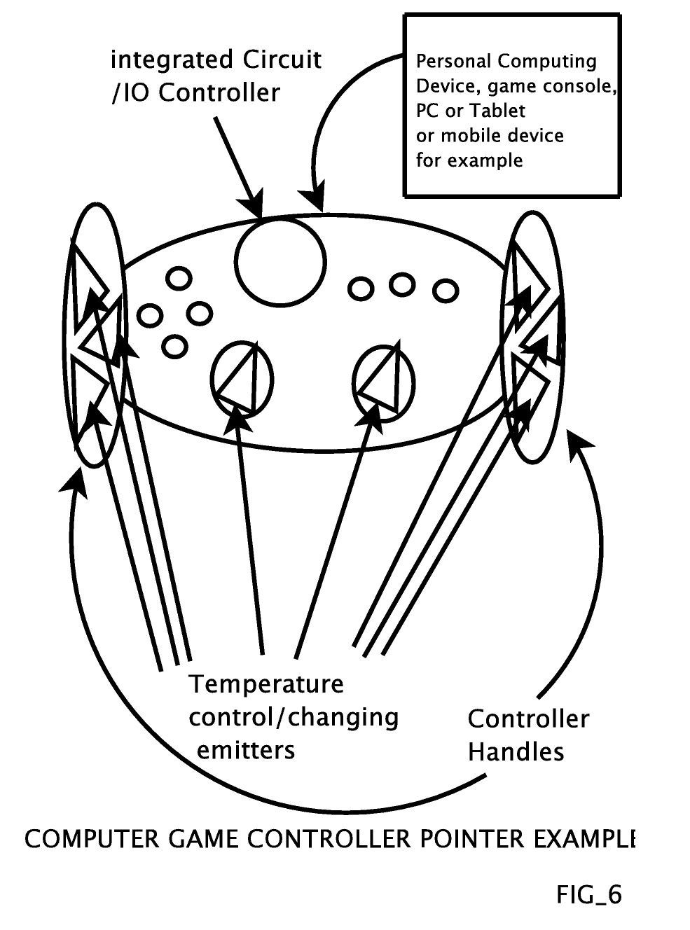

### FIG. 6—

Shows the pointing personal computing device peripheral embodiment as a game controller. The game controller has electronic components comprising of pads that conduct heat or cold throughout the surface of the device and does so based on binary or other software instructions sent to it from a game console via a data bus.

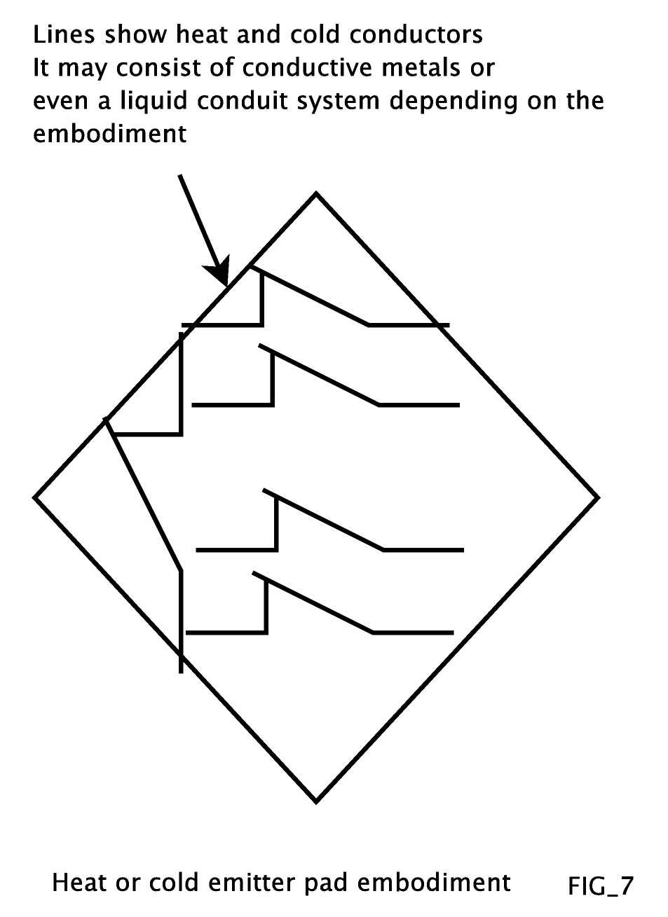

### FIG. 7—

Shows the one embodiment of a heating or cooling temperature emitting pad used in the apparatus to change the temperature of the surface of the device. It consists of heat and cold conductive material within the pad which is used to disperse heat or cold through out the surface of the apparatus casing. These would typically be mounted directly under the surface of the peripheral using the apparatus's casing.

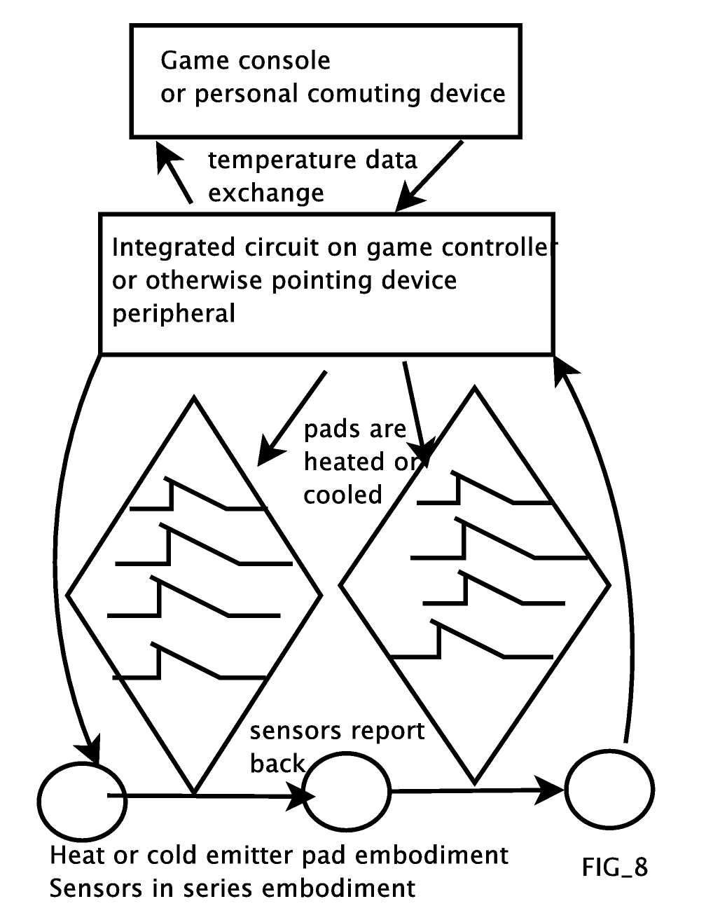

### FIG. 8—

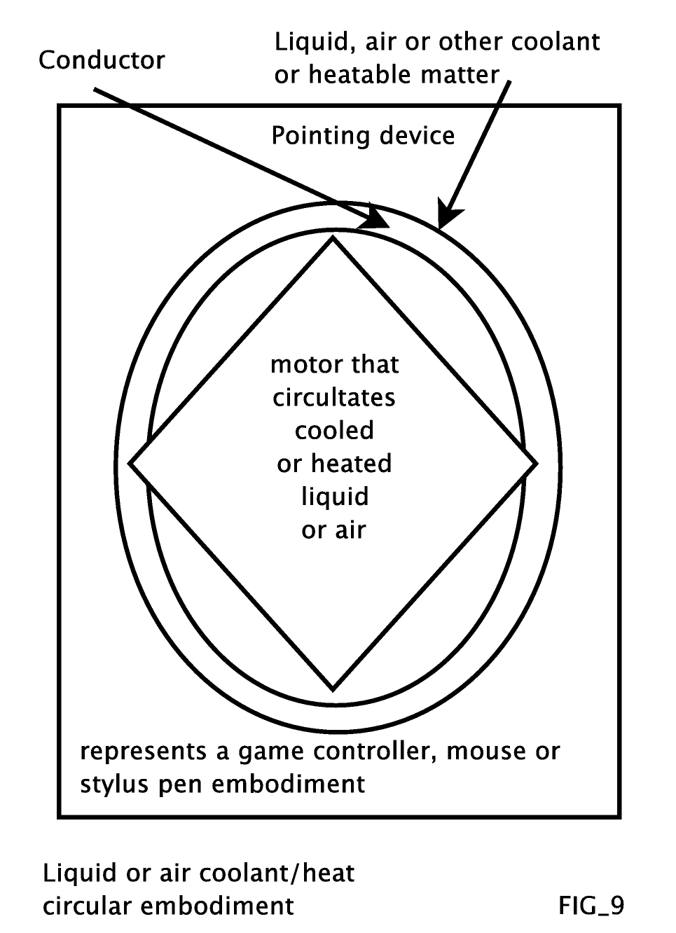

Shows the flow of data between the apparatus located inside the peripheral, such as mouse, stylus, or game controller embodiments, where the data is collected from the sensors, in this embodiment, the temperature sensors are wired in series, and sends the data to the connected game console or personal computing device. The game console or personal computing device sends data pertaining to what the temperature on the surface of the peripheral should be to the apparatus on the pointing device or game controller peripheral shown and it uses that information to change the surface temperature of the pointing peripheral or game controller sending heat or cold through conductive matter throughout the device via pads from FIG. 7 or the air or liquid heat and cold conduction system of FIG. 9.

### FIG. 9—

Shows the pointing personal computing device peripheral or game controller using an air or liquid circular conductive embodiment for transmitting heat or cold throughout the peripheral device or game controller's surface. In this embodiment a motor drives the heated or cooled liquid or air in a circular motion around the inner surface of the peripheral pointing device or game controller to heat or cool it as per was requested by the connected game console or personal computing device.

1. The method by which a hand operated computer hardware peripheral device connected to a personal computing device or game console by wire or wireless connection which; sends temperature data collected from the surface of the peripheral to the connected personal computing device via data exchange methods such as software interrupts and who's data output is interpreted by the connected computer to preform software actions; receives data from the personal computing device or game console connected to the pointing device peripheral or game controller indicating a request for a change in temperature to the surface of the pointing peripheral or game controller using the apparatus.

2. The method of claim 1, the apparatus consists of a host personal computer or gaming pointing peripheral such as a computer mouse, game controller or stylus pen in which it is embedded and consists of temperature sensors

3. The method of claim 1, the apparatus consists of a host personal computer or gaming pointing peripheral such as a computer mouse, game controller or stylus pen in which it is embedded and consists of temperature emitters consisting of a heating and or cooling system which changes the temperature of the host peripheral device.

4. The method of claim 2, the sensors in the hand held personal computer pointing peripheral or game controller detect and report temperature information about the surface of the peripheral device to the attached personal computing device via data exchange methods such as software interrupts and a data bus.

5. The method of claim 3, the heating or cooling system in the hand held personal computer pointing peripheral device or game controller receives instructions emitting from the connected personal computing device or game console and interprets those instructions to either heat up or cool the case surface of the hand held peripheral pointing device or game controller.

6. The method of claim 4, the software inside the personal computing device or game console attached to the peripheral pointer device or game controller reads and uses the data sent to it via a data bus in the course of it's software program directives.

7. The method of claim 5, the software and hardware of the apparatus inside the hand held peripheral pointer device or game controller attached to the personal computing device reads and uses the data sent to it via a data bus system to change the temperature of it's surface.

8. The method of claim 7, the software and hardware of the apparatus inside the hand held peripheral pointing device or game controller uses the data from the personal computing device or game console software to create context sensitive temperature changes that reflect the connected computer's software program's visual display on a screen or other visual output device.
